(19) United States
(12) Patent Application Publication
(10) Pub. No.: US 2010/0012619 A1
(43) Pub. Date: Jan. 21, 2010

(54) Towel and bottle system

(76) Inventor: Lisa Collins, Brea, CA (US)

Correspondence Address: MICHAEL A. SHIPPEY, PH. D., 4506 E. La Palma Avenue, Anaheim, CA, 92807, US

(21) Appl. No.: 12/586,108

(22) Filed: Sep. 17, 2009

Related U.S. Application Data
(63) Continuation-in-part of application No. 11/346,853, filed on Feb. 3, 2006, now abandoned.

(51) Int. Cl. B65D 23/06; B23P 19/04

(52) U.S. Cl. 215/392; 29/700

(57) ABSTRACT

This invention is a towel that attaches onto a drinking bottle and allows a person to quickly wipe and absorb fluids off their body. It acts as a guard against spills by the person drinking. The towel is made of lightweight, soft, and absorbent materials, which may be disposable or washable. The towel is constructed so as to be attached to the bottle without obscuring or covering the main label at the front of the bottle.

### PRIORITY OF THE INVENTION

The present application relates to, and is a Continuation-in-Part of, U.S. patent application Ser. No. 11/346,853, which application is incorporated by reference into the current application, and which prior application is hereby abandoned.

### BACKGROUND OF THE INVENTION

1. Field of the Invention

The present invention relates to a sports towel that is attachable to a standard commercial bottle or sports bottle at the neck of the bottle. The towel is easily accessible for wiping up water or other fluid. It is made of absorbing material that can be disposable or washable and that is lightweight and soft. It is either washable and reusable in one embodiment, or disposable in another embodiment. It is very convenient for cleanup in various situations. The towel is constructed so as to be attached to the bottle without obscuring or covering the main label at the front of the bottle.

2. Description of Related Art

No prior art was found that teaches the present invention.

Much of the prior art teaches towels attachable to beach chairs and furniture, rather than to a bottle. In US design patent D500,231, issued on Dec. 28, 2004 to inventors Ward and Nole, the design for a thermos bottle with permanently attached sleeve was disclosed. The sleeve may be a towel-like material, but the precise composition is not disclosed.

U.S. Pat. No. 5,441,789, issued on Aug. 15, 1995 to inventor G. Walker, presents an invention of a beach towel attachable to outdoor chairs, loungers, and the like.

U.S. Pat. No. 5,640,721, dated Jun. 24, 1997, to inventor R. Jackson, describes a sweatband with wiping towel. It is designed to be attached to the head of a person.

U.S. Pat. No. 6,182,309, issued on Feb. 6, 2001 to inventor W. Sullivan, teaches a beach towel with attached pillow and various straps.

Another series of prior art is focused on the prevention of bottle spillage, contamination, or breakage. U.S. Pat. No. 1,683,205 teaches a device that attaches to the bottom of a cup or bottle to catch drips and spills. U.S. Pat. Nos. 2,706,571 and 3,405,829 relate to rigid devices that cover the bottle for purposes of preventing breakage of the bottle. US Design Patent D458,380 teaches a decorated protective collar that slides over the bottle cap.

### SUMMARY OF THE INVENTION

The present invention relates to a towel that is attachable to a sports bottle or drinking bottle at the neck of the bottle. The towel is easily accessible for wiping and drying up fluids. It is made of absorbing material that can be disposable or washable and that is lightweight and soft. It is either washable and reusable in one embodiment, or disposable in another embodiment.

The towel has means for removable attachment to a bottle at the neck. In one embodiment, the means comprise an elastic collar attached to one end of the towel. The collar secures the towel to the bottle, and yet allows the towel to float freely at its free end, and thus to be used in the normal manner of a towel. Additionally, and optionally, a pair of straps is attached to the other end of the towel, opposite the collar. These straps are designed to removably fasten to each other, thus providing a second attachment point for the towel to the bottle.

The collar and straps can be constructed of elastic material, hook and loop and/or snap attachment elements. These elements, plus the design of the towel, allow it to fit snugly around a drinking bottle or a sports bottle. The towel can at any time be completely detached, to use separately from the bottle.

The towel is constructed so as to be attached to the bottle without obscuring or covering the main label at the front of the bottle.

### BRIEF DESCRIPTION OF THE DRAWINGS

The invention will now be described, by way of example only, with references to the accompanying drawings, as follows:

FIG. 1 depicts a preferred embodiment of the present invention from a perspective view, with the towel wrapping around the surface of the bottle, while displaying the label of the bottle.

FIG. 2 depicts the invention from a view directly above the bottle.

FIG. 3 shows the invention from underneath the bottle.

FIG. 4 shows a view of the invention from a frontal position, again mounted on a bottle.

FIG. 5 depicts the invention as viewed from the left side of the bottle, considering the open position of the invention to be mounted on the front side of the bottle.

FIG. 6 illustrates the invention as viewed from behind.

FIG. 7 depicts the invention as viewed from the right side.

FIG. 8 shows the invention in a different embodiment, fitted onto a wide mouth bottle.

### DETAILED DESCRIPTION OF THE INVENTION

The present invention relates to a towel that is attachable to a sports bottle at the neck of the bottle. The towel is easily accessible for wiping up and absorbing water or other fluid. It is made of absorbing material that can be disposable or washable, and that is lightweight and soft. It is either washable and reusable in one embodiment, or disposable in another embodiment. The towel also has a second attachment means at the bottom of the bottle. When attached both at the neck and the bottom of the bottle, the towel forms a close fitting cover for part of the bottle.

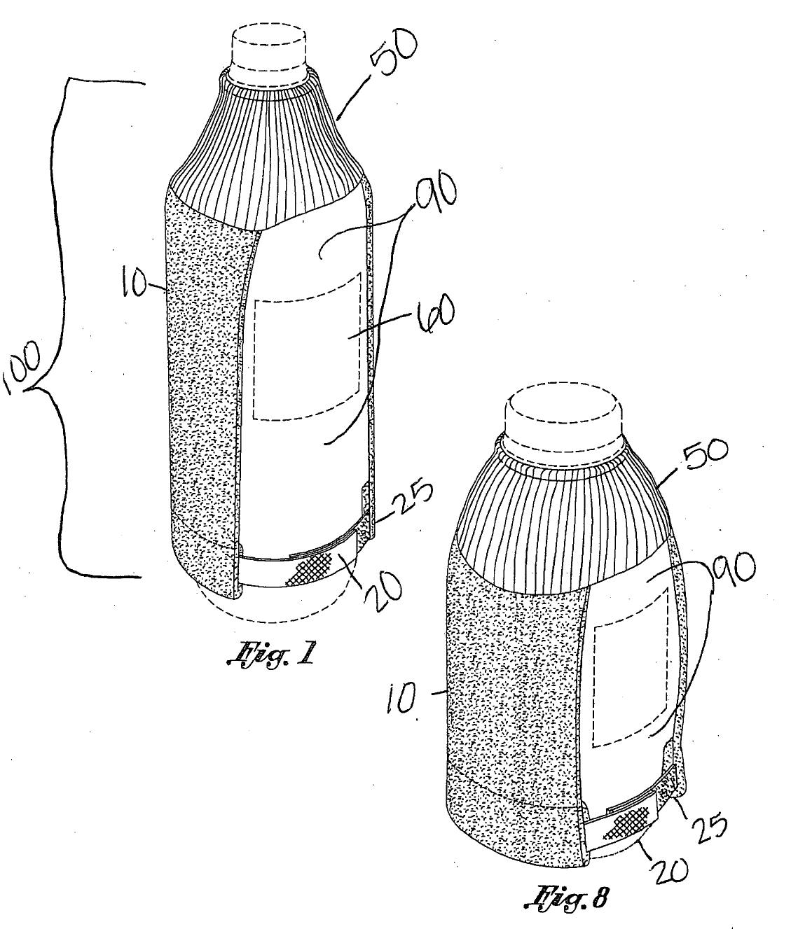

An important feature of the present invention is the intentional opening in the towel, the opening indicated as 90 in FIG. 1. Due to opening 90, the towel does not extend completely around the circumference of the entire bottle. Preferably, in displays for sale, the towel is arranged on the bottle such that opening 90 is positioned over the main label of the bottle. In this way, the invention does not interfere with the information on the label of the bottle. Said information is important in the marketing of the bottle and its contents. Viewing of the label is unimpaired when the present invention is properly attached in correct orientation on the bottle.

The disposable materials in a preferred embodiment of the current invention have been specially made for liquid absorption, such as paper or cotton batting or quilting materials. In its preferred embodiment, the towel material consists of a plurality of layers. For example, in a preferable mode, the invention comprises a three layer material consisting of a bottom layer of lightweight lining, an inner layer of a soft and absorbent cotton or synthetic batting or quilting covered by a top layer of semi-permeable or directionally-permeable material that captures liquid in such a way that it is absorbed into the inner absorbent layer, while the surface of the material stays dry or nearly dry. The exact material and construction can vary, but it is essential that the material be absorbent and liquid-capturing.

In another embodiment of the current invention, the towel can be constructed of a reusable, washable cloth. Terrycloth or cotton weave are preferred materials. The towel should be capable of absorbing moisture, and should be soft to the touch.

In FIG. 1 is seen the towel system 100 of the present invention. The towel body 10 fits snugly around the neck of a sports bottle 90. The sports bottle is a part of the current invention. It is used as a support in the preferred embodiment of the present invention.

The towel is secured to the bottle by an upper neck collar 50. This attachment means can be present in various embodiments, but as drawn, the upper attachment 50 is a ribbed neck collar. The attachment element 50 could be comprised of other similar attachment means, including, but not limited to, an elastic strap, hook and loop, or different type of fasteners.

The neck collar 50 is a vital feature of the present invention. This enables the towel to be slipped easily over the neck of a bottle or similar vessel. The towel may be allowed to drape freely from the neck of the bottle, as seen in later figures. Alternatively, the towel 10 can be fastened closely to the bottle by means of a fastening device at the lower end of the towel. The fastening means of the preferred embodiment depicted in this figure are straps 20 and 25. Straps 20 and 25 are mateable and fastenable, for instance, by use of hook and loop material. In an alternative preferred embodiment, a single strap 20 mates via hook and loop attachment means with a portion of the towel itself, thus simplifying the manufacturing by eliminated second strap 25.

Also shown in FIG. 1 is the bottle label 60. This is shown to indicate that proper mounting and use of the present invention does not obscure trade labels on the product bottles, as are commonly found on sports drinks and indeed virtually all commercially marketed bottles containing products sold to ordinary consumers.

FIG. 2 portrays the ribbed neck collar 50. This is the view of the present invention from above the bottle.

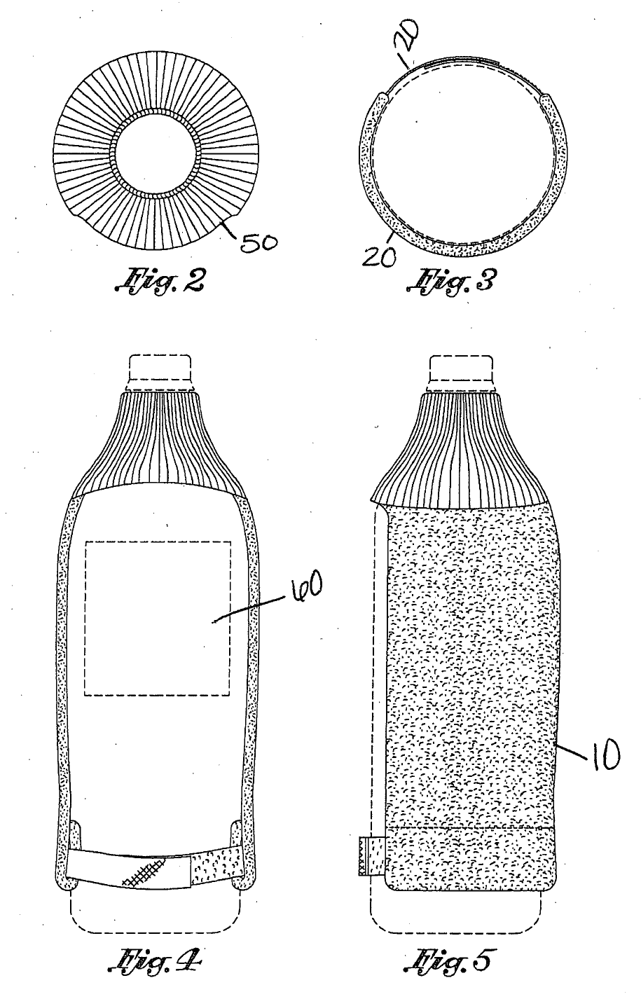

The towel in use on a bottle is shown in FIG. 3 from a view from underneath the bottle. The towel 10 does not extend beyond the bottom of the bottle. This allows the bottle to stand in a normal, vertically aligned position, with the present invention mounted on it.

The attachment collar 50 is designed to be easily attachable to and removable from the bottle. Removal can be accomplished by simply slipping the bottle out of the upper collar. Normally the collar 50 would be affixed to the towel 10, and indeed may form an integral portion thereof. However, in other embodiments of the current invention, the collar 50 would be removably attached to the towel 10.

FIG. 4 shows a straight on plan view of the present invention from directly in front. The invention is relatively unobtrusive on the shelves of a store. Only the fastening elements, upper collar 50 and lower fastening straps 20 and 25 are readily apparent. Indeed, the product branding label 60 is the most prominent feature of the bottle—as marketers prefer.

The purpose of the towel is to act as an absorbent towel, to be readily accessible to clean up any spill of liquid, condensation, or indeed sweat. For this it works very well when attached to the bottle per the current invention.

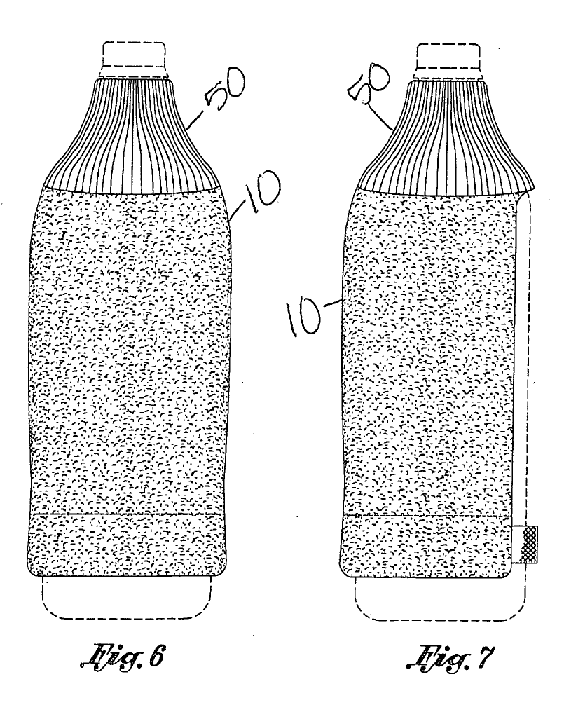

The current invention is especially adapted to be applied to sports bottles. FIGS. 5, 6, and 7 demonstrate the use in this scenario from different viewing perspectives.

FIG. 8 demonstrates that this invention can be adapted to any ordinary bottle. The bottle to which the towel attaches can be of various sizes. FIG. 8 shows a bottle with a wide mouth, with a towel according to the current invention attached. Ideally, the towel size is matched to the bottle size. But it is possible, within certain limits, to attach a small towel to a large bottle, or a large towel to a small bottle. The towel, for instance, can be longer than depicted, and indeed may exceed the length of the bottle to which it is attached. Indeed, this invention can be adapted to any bottle.

Of course, the towel can be used even before the contents of the bottle are consumed. The towel of the present invention, in a preferred embodiment is removably fastened on a bottle. It can subsequently be totally or partially detached from the bottle, and thereafter applied to remove the sweat off the brow of a hard working inventor. The bottle could be full, or empty. Either way, the bottle is acting as a support for a handy towel.

Additionally the towel can also be used even on a hot day to aid in a personal cooling process. One can envision the towel of the present invention hanging loose while suspended by the collar, on the neck of the bottle, while the user cools off on a hot day. The contents of the bottle are not disturbed. At the same time, the bottle is again acting as a support for a handy towel.

While the present invention has been described in terms of several preferred embodiments, it is not intended to limit the invention to the particular forms set forth. On the contrary, the present invention is intended to cover such alternatives, alterations, modifications, and equivalent structures and devices as may be included within the spirit and scope of the invention as defined within the appended claims.

I claim:

1. An apparatus, comprising the elements of:
A bottle used for containing liquids; and,
a flat towel, capable of absorbing water; wherein
said towel comprises means for removable attachment to said bottle,
wherein said towel can be closely fitted to said bottle, without covering the main label of said bottle.

2. The apparatus of claim 1, wherein said attachment means are capable of removably attaching said towel to the bottle at the neck of said bottle.

3. The apparatus of claim 1, further comprising a second attachment means for attaching the towel near the bottom of the bottle.

4. The apparatus of claim 1, wherein said towel extends from the fastening means at the top to the bottom of the bottle, when attached to the bottle.

5. The apparatus of claim 3, wherein at least one of said attachment elements comprise straps.

6. The apparatus of claim 3, wherein at least one of said attachment elements comprise hook and loop fastening means.

7. The apparatus of claim 1, wherein said bottle comprises a sports bottle.

8. The apparatus of claim 1, wherein at least one of said attachment elements comprise an elastic collar.

9. A apparatus comprising the elements of:
a towel, capable of absorbing water;
said towel having at least one attachment portion thereon, wherein said at least one said attachment element comprises a collar and a drinking bottle;
wherein said attachment portions allow said towel to be removably attached to the surface of said drinking vessel; and,
wherein said towel can be closely fitted to said bottle, without covering the main label of said bottle.

10. The apparatus of claim 9, wherein said drinking bottle comprises a sports bottle.

11. The apparatus of claim 9, wherein said attachment portions comprise straps.

12. The apparatus of claim 9, wherein said attachment portions comprise hook and loop fastening means.

13. The apparatus of claim 9, wherein said attachment portions comprise an elastic collar.

14. The apparatus of claim 9, wherein said attachment portions are capable of removably attaching said towel to the bottle.

15. A apparatus as described in claim 1, further comprising a packet attached to the underside of the towel, said packet capable of containing small items.

16. A apparatus as described in claim 1 in which said towel is further comprised of a single integral piece of construction, without need for assembly or fastening by the user, other than at two points near either end of said drinking vessel.

17. A apparatus as described in claim 1 in which said towel is further comprised of lightweight and soft, absorbent cloth.

18. A apparatus as described in claim 1 in which said towel is further comprised of a disposable cloth-like synthetic material, which is capable of absorbing liquid.

19. The method for using the apparatus of claim 1, comprising the steps of:
Attaching a connection collar to the top edge of said towel; and,
Removably attaching said towel to a drinking bottle via said attachment means and said attachment collar, wherein said collar is attached near the top of said vessel.
